(19) United States
(12) Patent Application Publication
(10) Pub. No.: US 2026/0051313 A1
(43) Pub. Date: Feb. 19, 2026

(54) VEHICLE NOISE MASKING DEVICE AND METHOD

(71) Applicants: HYUNDAI MOTOR COMPANY, Seoul (KR); KIA CORPORATION, Seoul (KR)

(72) Inventor: Kyoung Jin CHANG, Gyeonggi-do (KR)

(73) Assignees: HYUNDAI MOTOR COMPANY, Seoul (KR); KIA CORPORATION, Seoul (KR)

(21) Appl. No.: 19/052,533

(22) Filed: Feb. 13, 2025

(30) Foreign Application Priority Data
Aug. 16, 2024 (KR) 1020240109637

(51) Int. Cl. G10K 11/175

(52) U.S. Cl. CPC G10K 11/1752

(57) ABSTRACT

A vehicle noise masking device includes a database configured to store sound sources, a sound source classification unit configured to classify the sound sources into a first sound source group and a second sound source group, a communication unit, a first processing unit configured to analyze components of the noise measurement signals based on the traveling information and classify the noise measurement signals into vehicle-related noise and vehicle-unrelated noise, a second processing unit configured to extract a first masking sound source similar to the vehicle-related noise from the first sound source group, a third processing unit configured to extract a second masking sound source similar to the vehicle-unrelated noise from the second sound source group, and a fourth processing unit configured to generate a third masking sound source using at least one of the first masking sound source and the second masking sound source.

### CROSS-REFERENCE TO RELATED APPLICATION

The present application claims priority to Korean Patent Application No. 10-2024-0109637, filed on Aug. 16, 2024, the entire contents of which is incorporated herein for all purposes by this reference.

### BACKGROUND OF THE PRESENT DISCLOSURE

### Field of the Present Disclosure

The present disclosure relates to a vehicle noise masking device and method.

### Description of Related Art

A large amount of noise may be generated while a vehicle travels, and the noise may be transmitted to a driver and occupants. To reduce the noise, sound absorbing materials or soundproofing materials for fundamentally blocking a transmission path of a noise source may be added, or a logic for canceling noise may be reviewed. However, these technologies have a problem of increasing cost, and even when applied to reduce various types of noise generated in a vehicle traveling environment, there is a limitation that an effect of reducing noise is insignificant. Therefore, there is a demand for the development of a technology for classifying noise generated during a vehicle traveling process and masking the classified noise.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle noise masking device and method, which are configured for removing or reducing various noise generated in driving a vehicle.

According to an exemplary embodiment of the present disclosure, there is provided a vehicle noise masking device including a database configured to store sound sources, a sound source classification unit configured to classify the sound sources into a first sound source group and a second sound source group, a communication unit configured to collect noise measurement signals from a microphone mounted on a vehicle and collect traveling information of the vehicle through Controller Area Network (CAN) communication, a first processing unit configured to analyze components of the noise measurement signals based on the traveling information and classify the noise measurement signals into vehicle-related noise and vehicle-unrelated noise, a second processing unit configured to extract a first masking sound source similar to the vehicle-related noise from the first sound source group, a third processing unit configured to extract a second masking sound source similar to the vehicle-unrelated noise from the second sound source group, and a fourth processing unit configured to generate a third masking sound source using at least one of the first masking sound source and the second masking sound source.

The sound source classification unit may classify a sound source group based on a length, a repetition characteristic, an overlapping characteristic, and a beat characteristic of the sound source.

The first processing unit may classify the vehicle-related noise and the vehicle-unrelated noise through correlation analysis between the traveling information and the noise measurement signals.

The second processing unit may extract, as the first masking sound source, a sound source including a frequency pattern which is most similar to a frequency pattern of the vehicle-related noise from the first sound source group.

The second processing unit may analyze the frequency pattern using a level by each frequency band and a composition ratio of the vehicle-related noise.

The third processing unit may extract, as the second masking sound source, a sound source including a frequency pattern similar to a frequency pattern of the vehicle-unrelated noise from the second sound source group.

The third processing unit may extract, as the second masking sound source, a sound source including a beat tone pattern similar to an impact sound pattern of the vehicle-unrelated noise from the second sound source group.

The third processing unit may analyze the impact sound pattern using a generation period of noise including an intensity of a preset threshold value or more than the preset threshold value in the vehicle-unrelated noise.

The third processing unit may extract, as the second masking sound source, a sound source including a pattern similar to a frequency pattern and an impact sound pattern of the vehicle-unrelated noise from the second sound source group.

The third processing unit may select a sound source including a beat tone pattern similar to the impact sound pattern of the vehicle-unrelated noise, and extract, as the second masking sound source, a sound source including a frequency pattern similar to the frequency pattern of the vehicle-unrelated noise among the selected sound sources.

The fourth processing unit may adjust a volume of the first masking sound source using an intensity of the vehicle-related noise and adjust a volume of the second masking sound source using an intensity of the vehicle-unrelated noise to generate the third masking sound source.

According to another exemplary embodiment of the present disclosure, there is provided a vehicle noise masking method including collecting, by a communication unit, noise measurement signals from a microphone mounted on a vehicle and collecting traveling information of the vehicle through Controller Area Network (CAN) communication, analyzing, by a first processing unit, components of the noise measurement signals based on the traveling information, classifying, by the first processing unit, the noise measurement signals into vehicle-related noise and vehicle-unrelated noise, extracting, by a second processing unit, a first masking sound source which is most similar to the vehicle-related noise from the first sound source group, extracting, by a third processing unit, a second masking sound source similar to the vehicle-unrelated noise from the second sound source group, and generating, by a fourth processing unit, a third masking sound source using at least one of the first masking sound source and the second masking sound source.

The vehicle noise masking method may further include, before the extracting of the first masking sound source, classifying, by a sound source classification unit, sound source groups based on a length, a repetition characteristic, an overlapping characteristic, and a beat characteristic of the sound source and storing the classified sound source group in a database.

The classifying of the noise measurement signals may include classifying the vehicle-related noise and the vehicle-unrelated noise through correlation analysis between the traveling information and the noise measurement signals.

The extracting of the first masking sound source may include analyzing a frequency pattern of the vehicle-related noise, comparing the first sound source group with the frequency pattern of the vehicle-related noise, and extracting the first masking sound source which is most similar to the vehicle-related noise from the first sound source group.

The analyzing of the frequency pattern may include analyzing the frequency pattern using a level by each frequency band and a composition ratio of the vehicle-related noise.

The extracting of the second masking sound source may include extracting, as the second masking sound source, a sound source including a pattern similar to a frequency pattern and an impact sound pattern of the vehicle-unrelated noise from the second sound source group.

The extracting of the second masking sound source may include analyzing the frequency pattern and the impact sound pattern of the vehicle-unrelated noise, selecting a sound source including a beat tone pattern similar to the impact sound pattern of the vehicle-unrelated noise, and selecting, as the second masking sound source, a sound source including a frequency pattern similar to the frequency pattern of the vehicle-unrelated noise among the selected sound sources.

The analyzing of the impact sound pattern may include analyzing the impact sound pattern using a generation period of noise including an intensity of a preset threshold value or more than the preset threshold value in the vehicle-unrelated noise.

The generating of the third masking sound source may include adjusting a volume of the first masking sound source using an intensity of the vehicle-related noise, adjusting a volume of the second masking sound source using an intensity of the vehicle-unrelated noise, and generating a third masking sound source using at least one of the first and second masking sound sources whose volumes are adjusted.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of a configuration of a vehicle noise masking device according to an exemplary embodiment of the present disclosure;

FIG. 2 is a view for describing an operation of the vehicle noise masking device according to the embodiment;

FIG. 3 is a view for describing an operation of a sound source classification unit according to the embodiment;

FIG. 4 is a view for describing an operation of a second processing unit according to the embodiment;

FIG. 5, FIG. 6, FIG. 7 and FIG. 8 are views for describing an operation of a third processing unit according to the embodiment; and

FIG. 9A and FIG. 9B are flowcharts of a vehicle noise masking method according to the exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical spirit of the present disclosure is not limited to various exemplary embodiments which will be described and may be implemented in a variety of different forms, and one or more components of the exemplary embodiments of the present disclosure may be selectively combined, substituted, and used within the range of the technical spirit of the present disclosure.

Furthermore, unless clearly and specifically defined otherwise by the context, all terms (including technical and scientific terms) used herein can be interpreted as having meanings customarily understood by those skilled in the art, and the meanings of generally used terms, such as those defined in commonly used dictionaries, will be interpreted in consideration of contextual meanings of the related art.

In addition, the terms used in the exemplary embodiments of the present disclosure are considered in a descriptive sense only and not to limit the present disclosure.

In the present specification, unless specifically indicated otherwise by the context, singular forms include plural forms, and in a case in which “at least one (or one or more) among A, B, and C” is described, this may include at least one combination among all possible combinations of A, B, and C.

Furthermore, in descriptions of components of the present disclosure, terms such as “first,” “second,” “A,” “B,” “(a),” and “(b)” may be used.

The terms are only to distinguish one component from another component, and the essence, order, and the like of the components are not limited by the terms.

Furthermore, it should be understood that, when a first component is referred to as being “connected” or “coupled” to a second component, such a description may include both a case in which the first component is directly connected or coupled to the second component, and a case in which the first component is connected or coupled to the second component with a third component disposed therebetween.

Furthermore, when a first component is referred to as being formed or disposed “on” or “under” a second component, such a description includes both a case in which the two components are formed or disposed in direct contact with each other and a case in which one or more other components are located between the two components. Furthermore, when the first component is referred to as being formed “on or under” the second component, such a description may include a case in which the first component is formed at an upper side or a lower side with respect to the second component.

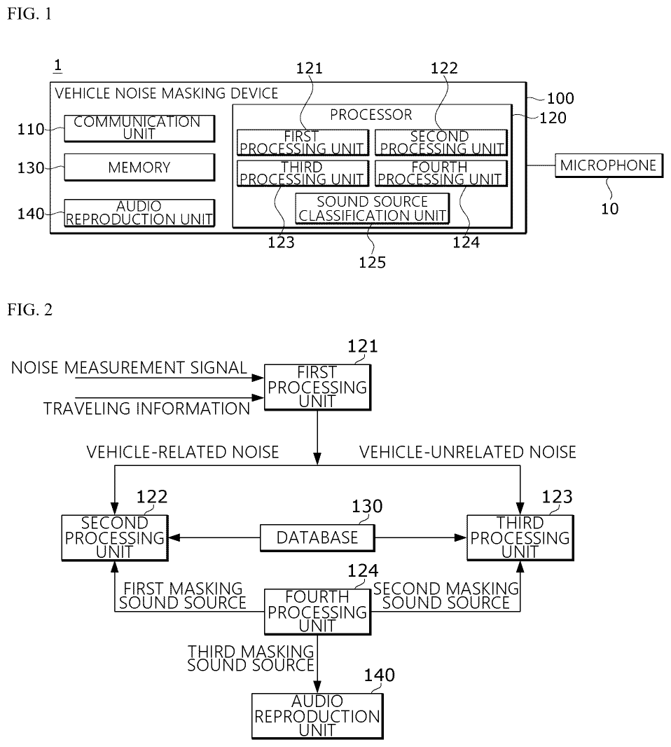

FIG. 1 is a block diagram of a configuration of a vehicle noise masking device according to an exemplary embodiment of the present disclosure, and FIG. 2 is a view for describing an operation of the vehicle noise masking device according to the exemplary embodiment of the present disclosure. Referring to FIG. 1 and FIG. 2, a microphone 10 mounted on a vehicle 1 may measure noise generated while the vehicle travels. The microphone 10 may be mounted inside or outside the vehicle to measure engine noise (or electric vehicle motor noise) generated in the vehicle 1, environmental noise (construction site noise, etc.) introduced externally, etc. A plurality of microphones 10 may be provided inside and outside the vehicle.

A vehicle noise masking device 100 according to the exemplary embodiment of the present disclosure may include a communication unit 110, a processor 120, a memory 130, and an audio reproduction unit 140.

In an exemplary embodiment of the present disclosure, the components may have different functions and capabilities in addition to the above and include additional components in addition to those to be described below. Furthermore, in an exemplary embodiment of the present disclosure, each component may be implemented using one or more physically separate devices, or implemented by one or more processors 120 or a combination of the one or more processors 120 and software, and may not be clearly distinguished in specific operations unlike the shown example.

The vehicle noise masking device 100 according to the exemplary embodiment of the present disclosure may be implemented in a logic circuit by hardware, firmware, software, or a combination thereof and implemented using a general-purpose or special-purpose computer. The device may be implemented using a hardwired device, a field programmable gate array (FPGA), an application specific integrated circuit (ASIC), etc. Furthermore, the device may be implemented as a system on chip (SoC) including the one or more processors 120 and a controller.

Furthermore, the vehicle noise masking device 100 may be mounted on a computing device or server provided with hardware elements in a form of software, hardware, or a combination thereof. The computing device or the server may be various devices including all or some of a communication device such as a communication modem for performing communication with various devices or a wired/wireless communication network, the memory 130 for storing data for executing a program, a microprocessor for executing a program to perform determinations and instructions, etc.

The communication unit 110 may support the vehicle noise masking device to communicate with electronic control units (ECUs) mounted on the vehicle. The communication unit 110 may include a transceiver for transmitting and receiving Controller Area Network (CAN) messages using a CAN protocol. The communication unit 110 may support the vehicle noise masking device 100 to communicate with external electronic devices (e.g., a terminal and a server). The communication unit 110 may include a wireless communication circuit and/or a wired communication circuit.

The communication unit 110 may receive traveling information of the vehicle 1 from the ECU of the vehicle 1 using CAN communication. For example, the traveling information may include at least one of revolutions per minute (RPM) of a motor, a pedal opening amount, a vehicle speed, a traveling mode, and a gear stage number. The communication unit 110 may transmit the collected traveling information to the processor 120.

The memory 130 may include a database (DB) for storing sound sources. The database may store various types of pieces of sound source data which may be used for noise masking. For example, the sound source data may include stream sound, wave sound, dance music with a constant beat, classical music without a beat, etc.

Furthermore, the memory 130 may be a non-transitory storage medium for storing instructions executed by the processor 120. The memory 130 may include at least one of a random access memory (RAM), a static random access memory (SRAM), a read only memory (ROM), a programmable read only memory (PROM), an electrically erasable PROM (EEPROM), an erasable PROM (EPROM), a Hard Disk Drive (HDD), a solid state disk (SSD), an embedded multimedia card (eMMC), a universal flash storage (UFS), and/or a web storage.

In an exemplary embodiment of the present disclosure, a first processing unit 121, a second processing unit 122, a third processing unit 123, a fourth processing unit 124, and a sound source classification unit 125 may be implemented through the same process, and for the convenience of description, an operation of each component will be described separately below.

The processor 120 may include at least one of processing devices such as an ASIC, a digital signal processor (DSP), a programmable logic device (PLD), an FPGA, a central processing unit (CPU), a microcontroller, and/or a microprocessor.

Herein, in an exemplary embodiment of the present disclosure, the first processing unit 121, the second processing unit 122, the third processing unit 123, the fourth processing unit 124, and the sound source classification unit 125 may be implemented as separate processors. Alternatively, the first processing unit 121, the second processing unit 122, the third processing unit 123, the fourth processing unit 124, and the sound source classification unit 125 may be implemented as a single processor.

The sound source classification unit 125 may classify sound sources into a first sound source group and a second sound source group and store the first and second sound sources in the database (DB). For example, the sound source classification unit 125 may classify the sound sources stored in the database based on a length of the sound source, a repetition characteristic, an overlapping characteristic, and a beat characteristic and store the sound sources into the first sound source group and the second sound source group.

The sound source classification unit 125 may classify the sound sources stored in the database into the first sound source group to be used for masking vehicle-related noise and the second sound source group to be used for masking vehicle-unrelated noise.

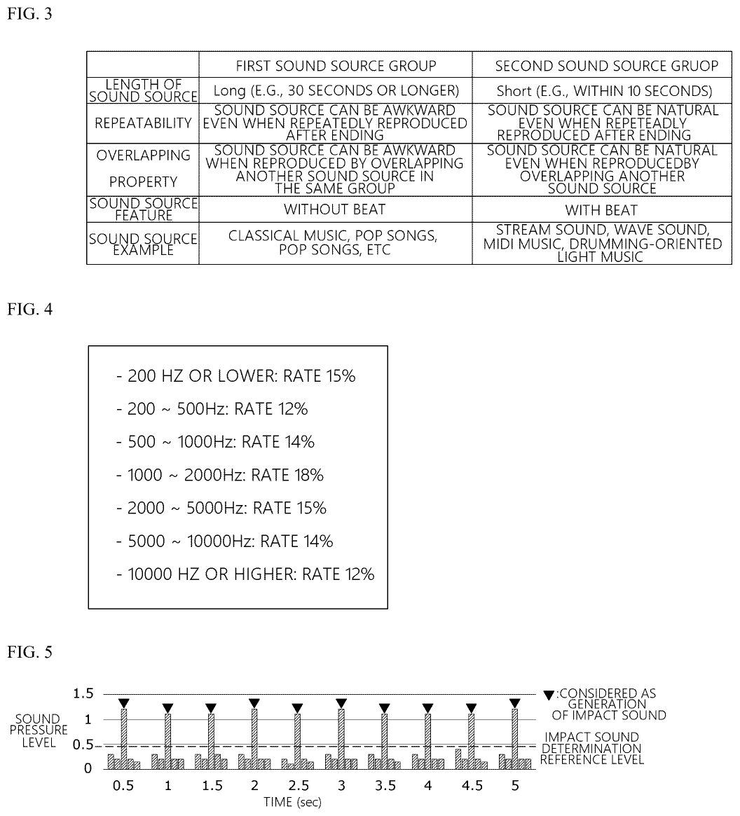

FIG. 3 is a view for describing an operation of a sound source classification unit according to the exemplary embodiment of the present disclosure. Referring to FIG. 3 together, the sound source classification unit 125 may classify in advance whether sound source data stored in the database is suitable for masking vehicle-related noise or masking vehicle-unrelated noise and store the sound source data as another sound source group. For example, the sound source classification unit 125 may classify a sound source that is short, repeatable, has a beat, and does not significantly damage other sound sources when reproduced by overlapping other sound sources as the second sound source group. For example, the second sound source group may include sound effects such as stream sound and wave sound, or short music with a strong beat.

Alternatively, the sound source classification unit 125 may classify a sound source which is long, has no beat, and overlaps other sound sources to cause awkwardness to a listener as the first sound source group. For example, the first sound source group may include classical music, songs with lyrics, pop songs, etc.

The sound source classification unit 125 may analyze the characteristics of the classified sound sources and store the characteristics together with the sound sources.

The sound source classification unit 125 may analyze frequency patterns of the first sound source group and the second sound source group and store the result of the analysis. The sound source classification unit 125 may classify frequency pattern analysis results into Root Mean Square (RMS) levels by each frequency band and store the same, or classify the frequency pattern analysis results into a Mel-frequency Cepstral coefficient (MFCC) and store the same.

The sound source classification unit 125 may perform short time Fourier transform (STFT) on the pieces of sound source data belonging to the first sound source group and the second sound source group and determine a ratio of the RMS level by each frequency band using the size of each frequency band from the sound source data transformed into the frequency band.

Alternatively, the sound source classification unit 125 may perform STFT on the pieces of sound source data belonging to the first sound source group and the second sound source group and then determine the MFCC.

The sound source classification unit 125 may classify the sound source data into frames (e.g., 20 ms to 40 ms) and apply STFT to determine a spectrum signal. The sound source classification unit 125 may apply a Mel filter bank to the determined spectrum signal to determine the Mel spectrum signal. The sound source classification unit 125 may apply Cepstral analysis to the determined Mel spectrum signal to determine the MFCC.

The sound source classification unit 125 may perform frequency pattern analysis on all sound source data belonging to the first sound source group and the second sound source group, classify the performed results into RMS levels or MFCCs by each frequency band, and display and store the RMS levels or the MFCCs as a composition ratio by each frequency band.

Furthermore, the sound source classification unit 125 may analyze and store a beat tone pattern of the second sound source group. The sound source classification unit 125 may store the result of the beat tone pattern analysis as a beat sound generation period.

The sound source classification unit 125 may extract a signal including a periodicity and a volume of a predetermined size or more to match the beat or indicate the tempo from the sound source data belonging to the second sound source group. The sound source classification unit 125 may store a period of the extracted signal as a beat sound period.

Alternatively, when the sound source data is a MIDI sound source, the sound source classification unit 125 may separate components of keyboard sound, string sound, and percussion sound from the sound source data, determine the period of the separated percussion sound, and store the period of the separated percussion sound as a beat sound period.

The sound source classification unit 125 may perform the beat tone pattern analysis on all sound source data belonging to the second sound source group, and display and store the result of the performance as a beat sound period.

Therefore, the sound source data belonging to the first sound source group may include frequency pattern information, and the sound source data belonging to the second sound source group may include frequency pattern information and beat tone pattern information and may be stored in the database.

The first processing unit 121 may analyze components of a noise measurement signal based on the traveling information and classify the noise measurement signal into vehicle-related noise and vehicle-unrelated noise.

In an exemplary embodiment of the present disclosure, the vehicle-related noise may be engine noise of a vehicle or motor noise of an electric vehicle and may be a predictable noise component through the traveling information. The vehicle-unrelated noise may be all noise components excluding vehicle-related noise and may be environmental noise such as construction site noise generated outside a vehicle.

The first processing unit 121 may classify the vehicle-related noise and the vehicle-unrelated noise through correlation analysis between the traveling information and the noise measurement signals.

For example, the first processing unit 121 may classify noise which is highly correlated with the traveling information in the noise measurement signal as the vehicle-related noise through multiple correlation analysis between a vehicle speed and revolutions per minute (RPM) value of the motor in the traveling information and a sound pressure level in the noise measurement signal.

Alternatively, the first processing unit 121 may analyze the traveling information and analyze the vehicle-related noise using the RPM noise level of the noise measurement signal according to main harmonics of an engine or main harmonics of the motor.

For example, a 4-cylinder engine may have main harmonics of the engine, such as 2^{nd}, 4^{th}, 6^{th}, and 8^{th} harmonics, and an electric vehicle motor with 8 poles may have main harmonics of the motor, such as 8^{th}, 16^{th}, 24^{th}, 32^{nd}, and 40^{th} harmonics. The first processing unit 121 may transform the noise measurement signal into a frequency domain, determine noise levels according to revolutions per minute (rpm) for each main harmonic of the engine or each main harmonic of the motor, and then reversely transform the noise measurement signal into a time domain to classify the vehicle-related noise.

The first processing unit 121 may separately extract the vehicle-related noise from the noise measurement signal and store the remaining signal in which the vehicle-related noise is separated from the noise measurement signal as the vehicle-unrelated noise.

The second processing unit 122 may extract a first masking sound source which is most similar to the vehicle-related noise from the first sound source group.

For example, the second processing unit 122 may analyze the frequency pattern using a frequency level by each frequency band and a composition ratio of the vehicle-related noise.

The second processing unit 122 may extract, as the first masking sound source, a sound source including a frequency pattern which is most similar to the frequency pattern of the vehicle-related noise from the first sound source group.

The second processing unit 122 may analyze the frequency pattern of the vehicle-related noise and store the result of the analysis. The second processing unit 122 may classify the result of the frequency pattern analysis into RMS levels by each frequency band and store the RMS levels, or classify the above result into MFCCs.

The second processing unit 122 may perform STFT on the vehicle-related noise and determine the ratio of the RMS levels by each frequency band using the intensity by each frequency band from the vehicle-related noise transformed into the frequency band.

Alternatively, the second processing unit 122 may perform STFT on the vehicle-related noise and then determine MFCCs.

The second processing unit 122 may classify the vehicle-related noise into frames (e.g., 20 ms to 40 ms) and apply STFT to determine a spectrum signal. The second processing unit 122 may apply the Mel filter bank to the determined spectrum signal to determine the Mel spectrum signal. The second processing unit 122 may apply the Cepstral analysis to the determined Mel spectrum signal to determine MFCCs.

FIG. 4 is a view for describing an operation of a second processing unit according to the exemplary embodiment of the present disclosure. Referring to FIG. 4 together, the second processing unit 122 may perform frequency pattern analysis, classify the result of the performance into RMS levels by each frequency band, and display and store the RMS levels as a composition ratio by each frequency band.

The second processing unit 122 may compare the frequency pattern of the vehicle-related noise with the frequency pattern of the first sound source group to determine similarity.

For example, the second processing unit 122 may be configured to determine a correlation coefficient between the ratios of the RMS levels by each frequency band to determine similarity. The second processing unit 122 may be configured to determine the correlation coefficient between the ratios of the RMS levels by each frequency band of the frequency pattern of the vehicle-related noise and the frequency band of the frequency pattern of the first sound source group as shown in Equation 1 below:

$${r}_{XY} = \frac{{\sum }_{i}^{n} ( {X}_{i} - \overline{X} ) ( {Y}_{i} - \overline{Y} )}{\sqrt{{\sum }_{i}^{n} {( {X}_{i} - \overline{X} )}^{2}} \sqrt{{\sum }_{i}^{n} {( {Y}_{i} - \overline{Y} )}^{2}}} \qquad [ Equation 1 ]$$

In Equation 1, r_{xy} denotes a correlation coefficient, Xᵢ denotes an RMS level in an i^{th} frequency band of the vehicle-related noise, Yᵢ denotes an RMS level in the ith frequency band of the sound source belonging to the first sound source group, X̅ denotes an RMS level average value in the entire band of the vehicle-related noise, Y̅ denotes an RMS level average value in the entire band of the sound source belonging to the first sound source group, and n denotes the number of frequency bands.

The second processing unit 122 may be configured to determine that the higher the correlation coefficient determined through Equation 1, the higher the similarity between the vehicle-related noise and the corresponding sound source.

Alternatively, the second processing unit 122 may be configured to determine the similarity between the vehicle-related noise and the sound source belonging to the first sound source group using MFCC. The second processing unit 122 may be configured to determine entropy using a KL-divergence method to determine similarity.

The second processing unit 122 may transform the Mel spectrum obtained from the MFCC of the sound source belonging to the first sound source group into a log scale and determine entropy (DKL) representing a difference between distributions of the vehicle-related noise and the sound source belonging to the first sound source group according to Equation 2 below based on the KL-divergence method.

$${D}_{KL} ( P ‖ Q ) = {\sum }_{x ∈ χ} P ( x ) log ( \frac{P ( x )}{Q ( x )} ) \qquad [ Equation 2 ]$$

In Equation 2, P denotes the log-Mel spectrum of the sound source, Q denotes the log-Mel spectrum of the vehicle-related noise, and D_{KL} denotes the entropy representing the difference between the distributions of the vehicle-related noise and the sound source belonging to the first sound source group.

The second processing unit 122 may repeatedly determine D_{KL} for all the sound sources belonging to the first sound source group and the vehicle-related noise and determine an average and standard deviation for normal distribution using Equations 3 and 4 below:

$$N ( x \vert μ , {σ}^{2} ) ≡ \frac{1}{σ \sqrt{2 π}} exp [ - \frac{{( x - μ )}^{2}}{2 {σ}^{2}} ] \qquad [ Equation 3 ]$$

$$μ = {\sum }_{i = 1}^{m} {D}_{KL} ( Pi ‖ Q ) \qquad [ Equation 4 ]$$

In Equations 3 and 4, N(x|μσ²) denotes the normalized D_{KL}, Pi denotes the log-Mel spectrum of the i^{th} sound source (i=1 to m (natural number)), Q denotes the log-Mel spectrum of the vehicle-related noise, μ denotes the average value of D_{KL}s of m sound sources, and σ denotes the standard deviation of the D_{KL}s of the m sound sources.

The second processing unit 122 may derive a normalized probability density function by substituting the D_{KL} (i.e., D_{KL}(Pi|Q) between the ith sound source and the vehicle-related noise into the normalized N value of Equation 3. In the instant case, when the value of the DKL is large, it may mean that the relevance between the vehicle-related noise and the sound source is low, and when the above value is small, it may mean that the relevance is high. Therefore, the second processing unit 122 may display and store a value obtained by subtracting the normalized D_{KL} from the D_{KL} value determined in Equation 2 as a similarity value between the vehicle-related noise and the sound source.

The second processing unit 122 may select a sound source with the highest similarity determined by the above-described method from the first sound source group and extract the selected sound source as the first masking sound source.

The third processing unit 123 may extract a second masking sound source similar to the vehicle-unrelated noise from the second sound source group.

The third processing unit 123 may analyze the frequency pattern and an impact sound pattern of the vehicle-unrelated noise.

The third processing unit 123 may analyze the frequency pattern of the vehicle-unrelated noise and store the result of the analysis. The third processing unit 123 may classify the result of the frequency pattern analysis into RMS levels by each frequency band and store the RMS levels, or classify the above result into MFCCs and store the MFCCs.

The third processing unit 123 may perform STFT on the vehicle-unrelated noise and determine the ratio of the RMS levels by each frequency band using the intensity by each frequency band from the vehicle-unrelated noise transformed into the frequency band.

Alternatively, the third processing unit 123 may perform STFT on the vehicle-unrelated noise and then determine MFCCs.

The third processing unit 123 may classify the vehicle-unrelated noise into frames and apply STFT to determine a spectrum signal. The third processing unit 123 may apply the Mel filter bank to the determined spectrum signal to determine the Mel spectrum signal. The third processing unit 123 may apply the Cepstral analysis to the determined Mel spectrum signal to determine MFCCs.

The third processing unit 123 may perform the frequency pattern analysis on the vehicle-unrelated noise, classify the result of the performance into the RMS levels by each frequency band or MFCCs, and display and store the RMS levels or the MFCCs as a composition ratio by each frequency band.

Furthermore, the third processing unit 123 may analyze the impact sound pattern of the vehicle-unrelated noise and store the result of the analysis. The third processing unit 123 may store the result of the impact sound pattern analysis as an impact sound generation period.

The third processing unit 123 may be configured to determine whether the vehicle-unrelated noise is a signal with periodicity. The third processing unit 123 may be configured to determine that a signal with a sound pressure of a predetermined level or higher is a signal with periodicity when the above signal is repeatedly generated at time intervals.

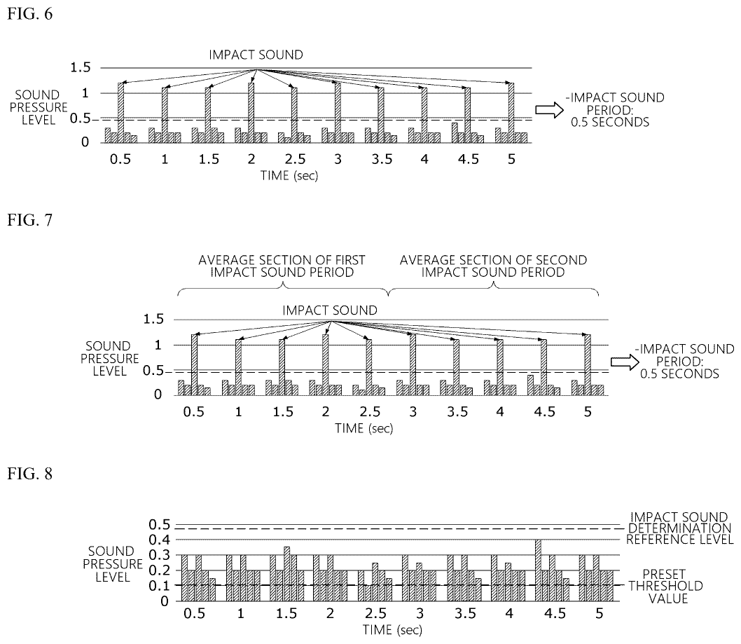

FIG. 5, FIG. 6, FIG. 7 and FIG. 8 are views for describing an operation of a third processing unit according to the exemplary embodiment of the present disclosure. Referring to FIG. 5 and FIG. 6 together, the third processing unit 123 may divide the vehicle-unrelated noise into the minimum time (e.g., 0.1 seconds) for which a person may recognize impact noise and determine a sound pressure level according to each divided time interval. The third processing unit 123 may be configured to determine that a signal whose each sound pressure level exceeds a preset impact sound determination reference level is an impact sound.

The third processing unit 123 may be configured to determine a generation interval of the determined impact sound and store the generation interval as an impact sound generation period.

Referring to FIG. 7 together, the third processing unit 123 may count each period in which the impact sound is generated for a regular time or the time for which the impact sound is generated the constant number of times (e.g., the time for which the impact sound is generated 5 times) when the impact sound generation interval is variable and store a value obtained by arithmetically averaging the counted periods as an impact sound period. For example, the third processing unit 123 may be configured to determine an average value of time intervals between impact sounds generated between 0 and 2.5 seconds and store the average value as the impact sound generation period during the corresponding time section. Furthermore, the third processing unit 123 may be configured to determine an average value of time intervals between impact sounds generated between 2.5 and 5 seconds and store the average value as the impact sound generation period during the corresponding time section.

The third processing unit 123 may display and store the result of the impact sound pattern analysis as the impact sound period.

The third processing unit 123 may compare at least one of the frequency pattern and the impact sound pattern with the second sound source group to select the second masking sound source.

Referring to FIG. 8 together, the third processing unit 123 may compare the impact sound pattern when an impact sound is present in the vehicle-unrelated noise to select the second masking sound source.

Alternatively, the third processing unit 123 may compare the frequency patterns with the impact sound patterns when the impact sound is present in the vehicle-unrelated noise to select the second masking sound source.

Alternatively, when no impact sound is present in the vehicle-unrelated noise but the average sound pressure level of the vehicle-unrelated noise exceeds a preset threshold value, the third processing unit 123 may compare the frequency pattern to select the second masking sound source.

Alternatively, when no impact sound is present in the vehicle-unrelated noise and the average sound pressure level of the vehicle-unrelated noise does not exceed the preset threshold value, the third processing unit 123 may not select the second masking sound source. In the instant case, as will be described below, a third masking sound source may be generated using only the first masking sound source.

For example, the third processing unit 123 may extract, as the second masking sound source, a sound source including a beat tone pattern which is most similar to the impact sound pattern of the vehicle-unrelated noise from the second sound source group. That is, when it is determined that the impact sound is present in the vehicle-unrelated noise, the third processing unit 123 may compare the impact sound period of the vehicle-unrelated noise with the beat sound period of the sound source to extract the second masking sound source.

The third processing unit 123 may compare whether an integer multiple value of the impact sound period of the vehicle-unrelated noise matches an integer multiple value of the beat sound period of the sound source according to Equation 5 below. The third processing unit 123 may be configured to determine that the corresponding sound source matches the vehicle-unrelated noise when at least one of preset j (natural number) and k (natural number) values satisfies Equation 5.

If {abs(beat sound period x j−impact sound period x k)<allowable value}, then beat tone patterns match [Equation 5]

Here, j and k denote set values, and even when each of the beat sound and the impact sound corresponds to an integer multiple value of the other, it is determined that the beat sound matches the impact sound, achieving the masking effect in the case of the integer multiple values of each other. However, when the j or k value increases, a masking time decreases, reducing the masking effect. Therefore, the j and k values may be set to various values depending on masking performance and may be, for example, set to a value smaller than 4. That is, when the j and k values are set too small, the masking performance is improved but it is difficult to select a matching sound source, and when the j and k values are set too large, a number of second masking sound sources are selected but the masking performance may be relatively reduced. Therefore, the j and k values may be set to natural numbers smaller than 4 based on the masking performance and the convenience of sound source selection. Furthermore, an allowable value in Equation 5 may be set to 5% to 10% (e.g., 0.05 seconds) of the general impact sound period as an offset value.

The third processing unit 123 may select at least one second masking sound source that satisfies Equation 5. Since the second masking sound sources do not cause significant interference even when overlapping each other and do not sound awkward to the listener, a plurality of second masking sound sources may be selected.

For example, the third processing unit 123 may extract, as the second masking sound source, a sound source including a frequency pattern which is similar to the frequency pattern of the vehicle-unrelated noise from the second sound source group. That is, when the impact sound is not present in the vehicle-unrelated noise but the average sound pressure level of the vehicle-unrelated noise exceeds the preset threshold value, the third processing unit 123 may compare the frequency pattern to select the second masking sound source.

The process of comparing the frequency pattern to select the second masking sound source is the same as the above-described process of comparing the frequency pattern and selecting the first masking sound source of the second processing unit 122, and overlapping descriptions thereof will be omitted. In the instant case, the third processing unit 123 may extract at least one second masking sound source including the similarity of the preset similarity or higher.

For example, the third processing unit 123 may extract, as the second masking sound source, a sound source including a pattern which is most similar to the frequency pattern and impact sound pattern of the vehicle-unrelated noise from the second sound source group. That is, when it is determined that the impact sound is present in the vehicle-unrelated noise, the third processing unit 123 may compare the impact sound pattern of the vehicle-unrelated noise with the beat tone pattern to select the sound source and select, as the second masking sound source, a sound source including a frequency pattern similar to the frequency pattern of the vehicle-unrelated noise among the selected sound sources.

That is, the third processing unit 123 may first compare the impact sound of the vehicle-unrelated noise with the beat tone pattern of the sound source to select at least one second masking sound source candidate group. The third processing unit may compare the frequency pattern of the second masking sound source candidate group with the frequency pattern of the vehicle-unrelated noise to select a sound source including a similar frequency pattern as the second masking sound source. In the instant case, the third processing unit 123 may extract at least one second masking sound source including the similarity of the preset similarity or higher.

The fourth processing unit 124 may be configured to generate the third masking sound source using at least one of the first masking sound source and the second masking sound source. The fourth processing unit 124 may overlap the first masking sound source and the second masking sound source on the time axis to generate the third masking sound source.

The fourth processing unit 124 may adjust a volume of the first masking sound source using an intensity of the vehicle-related noise and adjust a volume of the second masking sound source using an intensity of the vehicle-unrelated noise. The fourth processing unit 124 may be configured to determine the level of the masking sound source as an RMS value during the entire time section, and display and store the RMS value in decibels. Furthermore, the fourth processing unit 124 may be configured to determine the RMS levels of the vehicle-related noise and the vehicle-unrelated noise for a predetermined time period, and display and store the RMS levels in decibels.

The fourth processing unit 124 may adjust the RMS level of the first masking sound source according to the RMS level of the vehicle-related noise and adjust the RMS level of the second masking sound source according to the RMS level of the vehicle-unrelated noise. The fourth processing unit 124 may be configured to determine a volume gain of the masking sound source so that the volume of the masking sound source may be output to be greater than or equal to the volume of the noise to maximize the masking effect. The fourth processing unit may be configured to determine the volume gain of the masking sound source according to Equation 6 below.

$$Gain\_masking = C\_correction \times RMS\_noise ( dB ) \div RMS\_making ( dB ) \qquad [ Equation 6 ]$$

In Equation 6, Gain_masking denotes the volume gain of the first masking sound source or the second masking sound source, RMS_noise denotes the RMS level (dB) of the vehicle-related noise or the vehicle-unrelated noise, RMS_making denotes the RMS level (dB) of the first masking sound source or the second masking sound source, and C_correction denotes a correction constant. The correction constant is a value for adjusting the volumes of the noise and the masking sound source so that the volumes are similar or a difference between the volumes is large and may have, for example, a value ranging from 1 to 1.2.

The audio reproduction unit 140 may reproduce the third masking sound source generated by the fourth processing unit 124. The audio reproduction unit 140 may reproduce the sound and output the sound to speakers mounted inside the vehicle. The audio reproduction unit 140 may reproduce and output a sound source which is stored in advance or streamed in real time. The audio reproduction unit 140 may include an amplifier, a sound reproduction device, etc. The audio reproduction unit 140 may adjust a volume, a tone (sound quality), a sound image, etc. of the sound according to the instruction of the processor 120 to reproduce the sound. The sound reproduction device may include a digital signal processor (DSP) and/or a microprocessor. The amplifier may amplify an electric signal of the sound reproduced by the sound reproduction device.

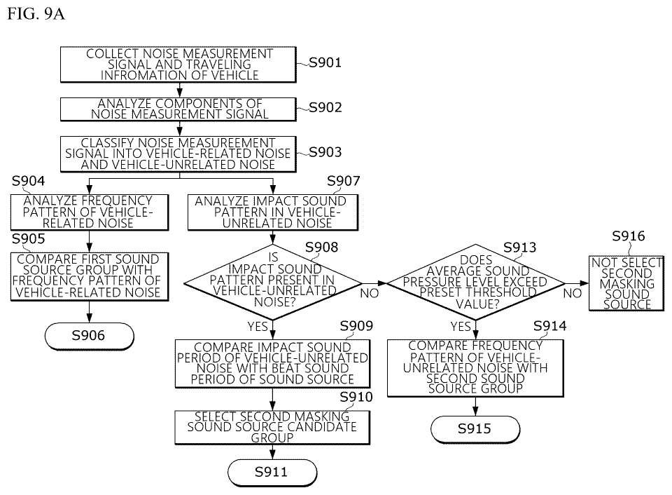

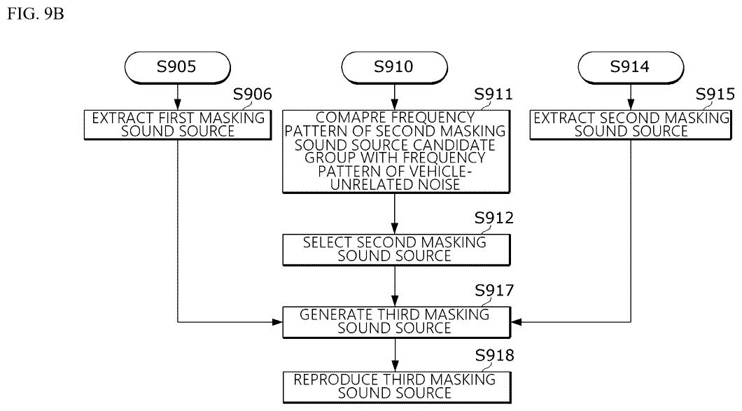

FIG. 9A and FIG. 9B are flowcharts of a vehicle noise masking method according to an exemplary embodiment of the present disclosure.

Referring to FIG. 9A and FIG. 9B, the communication unit collects a noise measurement signal from a microphone mounted on a vehicle and collects vehicle traveling information through CAN communication (S901).

Next, the first processing unit analyzes components of the noise measurement signal based on the traveling information (S902).

Next, the first processing unit classifies the noise measurement signal into vehicle-related noise and vehicle-unrelated noise (S903).

Next, the second processing unit analyzes a frequency pattern of the vehicle-related noise (S904).

Next, the second processing unit compares a first sound source group with the frequency pattern of the vehicle-related noise (S905).

Next, the second processing unit extracts a first masking sound source which is most similar to the vehicle-related noise from the first sound source group (S906).

The third processing unit analyzes an impact sound pattern using a generation cycle of noise including an intensity of a preset threshold value or more than the preset threshold value in the vehicle-unrelated noise (S907).

Next, when an impact sound pattern is present in the vehicle-unrelated noise, the third processing unit compares the impact sound period of the vehicle-unrelated noise with the beat sound period of the sound source (S908 and S909).

Next, the third processing unit selects at least one second masking sound source candidate group including a beat sound period similar to the impact sound period of the vehicle-unrelated noise (S910 and S911).

Next, the third processing unit compares a frequency pattern of the second masking sound source candidate group with the frequency pattern of the vehicle-unrelated noise (S911).

Next, the third processing unit selects, as a second masking sound source, a sound source including a frequency pattern similar to the frequency pattern of the second masking sound source candidate group (S912).

Alternatively, when the impact sound is not present in the vehicle-unrelated noise but the average sound pressure level of the vehicle-unrelated noise exceeds a preset threshold value, the third processing unit compares the frequency pattern of the vehicle-unrelated noise with the second sound source group (S913 and S914).

Next, the third processing unit extracts the second masking sound source which is most similar to the vehicle-unrelated noise from the second sound source group (S914 and S915).

Alternatively, the third processing unit does not select the second masking sound source when no impact sound is present in the vehicle-unrelated noise and the average sound pressure level of the vehicle-unrelated noise does not exceed the preset threshold value (S916).

The process of selecting the first masking sound source and the process of selecting the second masking sound source may be performed simultaneously, or the process of selecting any one masking sound source may be performed before the process of selecting the other masking sound source.

Next, the fourth processing unit generates a third masking sound source using at least one of the first masking sound source and the second masking sound source. In the instant case, the fourth processing unit adjusts a volume of the first masking sound source using an intensity of the vehicle-related noise, adjusts the volume of the second masking sound source using the intensity of the vehicle-unrelated noise, and then generates the third masking sound source (S917).

Next, the audio reproduction unit reproduces the third masking sound source (S918).

The processor is configured to repeatedly perform the process of selecting the first masking sound source and the second masking sound source to generate the third masking sound source when the characteristics of the noise measurement signal being collected periodically are changed out of an error range.

According to a vehicle noise masking device and method according to an exemplary embodiment of the present disclosure, it is possible to classify noise generated in driving a vehicle according to the driving relevance of the vehicle and mask each of the classified noise.

Therefore, it is possible to greatly reduce noise affected to a vehicle occupant.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle noise masking apparatus comprising:
a database configured to store sound sources;
a sound source classification unit configured to classify the sound sources into a first sound source group and a second sound source group;
a communication unit configured to collect noise measurement signals from a microphone mounted on a vehicle and collect traveling information of the vehicle through Controller Area Network (CAN) communication;
a first processing unit configured to analyze components of the noise measurement signals based on the traveling information and classify the noise measurement signals into vehicle-related noise and vehicle-unrelated noise;
a second processing unit configured to extract a first masking sound source similar to the vehicle-related noise from the first sound source group;
a third processing unit configured to extract a second masking sound source similar to the vehicle-unrelated noise from the second sound source group; and
a fourth processing unit configured to generate a third masking sound source using at least one of the first masking sound source and the second masking sound source.

2. The vehicle noise masking apparatus of claim 1, wherein the sound source classification unit classifies sound source groups based on a length, a repetition characteristic, an overlapping characteristic, and a beat characteristic of the sound sources.

3. The vehicle noise masking apparatus of claim 1, wherein the first processing unit classifies the vehicle-related noise and the vehicle-unrelated noise through correlation analysis between the traveling information and the noise measurement signals.

4. The vehicle noise masking apparatus of claim 1, wherein the second processing unit extracts, as the first masking sound source, a sound source including a frequency pattern which is most similar to a frequency pattern of the vehicle-related noise from the first sound source group.

5. The vehicle noise masking apparatus of claim 4, wherein the second processing unit analyzes the frequency pattern using a level by each frequency band and a composition ratio of the vehicle-related noise.

6. The vehicle noise masking apparatus of claim 1, wherein the third processing unit extracts, as the second masking sound source, a sound source including a frequency pattern similar to a frequency pattern of the vehicle-unrelated noise from the second sound source group.

7. The vehicle noise masking apparatus of claim 1, wherein the third processing unit extracts, as the second masking sound source, a sound source including a beat tone pattern similar to an impact sound pattern of the vehicle-unrelated noise from the second sound source group.

8. The vehicle noise masking apparatus of claim 7, wherein the third processing unit analyzes the impact sound pattern using a generation period of noise including an intensity of a preset threshold value or more than the preset threshold value in the vehicle-unrelated noise.

9. The vehicle noise masking apparatus of claim 1, wherein the third processing unit extracts, as the second masking sound source, a sound source including a pattern similar to a frequency pattern and an impact sound pattern of the vehicle-unrelated noise from the second sound source group.

10. The vehicle noise masking apparatus of claim 9, wherein the third processing unit selects a sound source including a beat tone pattern similar to the impact sound pattern of the vehicle-unrelated noise, and extracts, as the second masking sound source, a sound source including a frequency pattern similar to the frequency pattern of the vehicle-unrelated noise among the selected sound sources.

11. The vehicle noise masking apparatus of claim 1, wherein the fourth processing unit adjusts a volume of the first masking sound source using an intensity of the vehicle-related noise and adjusts a volume of the second masking sound source using an intensity of the vehicle-unrelated noise to generate the third masking sound source.

12. A vehicle noise masking method comprising:
collecting, by a communication unit, noise measurement signals from a microphone mounted on a vehicle and collecting traveling information of the vehicle through Controller Area Network (CAN) communication;
analyzing, by a first processing unit, components of the noise measurement signals based on the traveling information;
classifying, by the first processing unit, the noise measurement signals into vehicle-related noise and vehicle-unrelated noise;
extracting, by a second processing unit, a first masking sound source which is most similar to the vehicle-related noise from the first sound source group;
extracting, by a third processing unit, a second masking sound source similar to the vehicle-unrelated noise from the second sound source group; and
generating, by a fourth processing unit, a third masking sound source using at least one of the first masking sound source and the second masking sound source.

13. The vehicle noise masking method of claim 12, further including:
before the extracting of the first masking sound source, classifying, by a sound source classification unit, sound source groups based on a length, a repetition characteristic, an overlapping characteristic, and a beat characteristic of the sound sources and storing the classified sound source groups in a database.

14. The vehicle noise masking method of claim 12, wherein the classifying of the noise measurement signals includes classifying the vehicle-related noise and the vehicle-unrelated noise through correlation analysis between the traveling information and the noise measurement signals.

15. The vehicle noise masking method of claim 12, wherein the extracting of the first masking sound source includes:
analyzing a frequency pattern of the vehicle-related noise;
comparing the first sound source group with the frequency pattern of the vehicle-related noise; and
extracting the first masking sound source which is most similar to the vehicle-related noise from the first sound source group.

16. The vehicle noise masking method of claim 15, wherein the analyzing of the frequency pattern includes analyzing the frequency pattern using a level by each frequency band and a composition ratio of the vehicle-related noise.

17. The vehicle noise masking method of claim 12, wherein the extracting of the second masking sound source includes extracting, as the second masking sound source, a sound source including a pattern similar to a frequency pattern and an impact sound pattern of the vehicle-unrelated noise from the second sound source group.

18. The vehicle noise masking method of claim 17, wherein the extracting of the second masking sound source includes:
analyzing the frequency pattern and the impact sound pattern of the vehicle-unrelated noise;
selecting a sound source including a beat tone pattern similar to the impact sound pattern of the vehicle-unrelated noise; and
selecting, as the second masking sound source, a sound source including a frequency pattern similar to the frequency pattern of the vehicle-unrelated noise among the selected sound sources.

19. The vehicle noise masking method of claim 18, wherein the analyzing of the impact sound pattern includes analyzing the impact sound pattern using a generation period of noise including an intensity of a preset threshold value or more than the preset threshold value in the vehicle-unrelated noise.

20. The vehicle noise masking method of claim 12, wherein the generating of the third masking sound source includes:
adjusting a volume of the first masking sound source using an intensity of the vehicle-related noise;
adjusting a volume of the second masking sound source using an intensity of the vehicle-unrelated noise; and
generating the third masking sound source using at least one of the first and second masking sound sources whose volumes are adjusted.
